(19) United States
(12) Patent Application Publication
(10) Pub. No.: US 2026/0339578 A1
(43) Pub. Date: Oct. 29, 2026

(54) COMPUTER-IMPLEMENTED METHOD, SERVER, CLIENT, NETWORK SYSTEM AND COMPUTER-READABLE STORAGE MEDIA

(71) Applicant: Macher Fuer Morgen GmbH, Augsburg (DE)

(72) Inventors: Michel Heide, Augsburg (DE); Juergen Schmachtel, Augsburg (DE)

(21) Appl. No.: 19/102,466

(22) PCT Filed: Aug. 9, 2023
(86) PCT No.: PCT/EP2023/072089

§ 371 Date: Feb. 10, 2025

(30) Foreign Application Priority Data
Aug. 10, 2022 (DE) 10 2022 120 184.8

(51) Int. Cl. G06F 3/12; G06K 15/02

(52) U.S. Cl. CPC G06F 3/1208; G06F 3/1253; G06F 3/1288; G06K 15/1843

(57) ABSTRACT

A computer-implemented method includes the following steps: loading an original image from a memory, reducing and/or compressing the original image to form a thumbnail image, transmitting the thumbnail image to a client, receiving, from the client, a medium size of a printing medium and features of a thumbnail image region that corresponds to the medium size and desired content of the printing medium in the thumbnail image, transforming the thumbnail image region onto the original image to obtain an original image region that is to be printed onto the medium so as to fill the surface of the medium, and outputting a printing command to a printer to print the original image region onto the medium so as to fill the surface of the medium.

### CROSS-REFERENCE TO RELATED APPLICATIONS

This application is the United States national stage entry of International Application No. PCT/EP2023/072089, filed on Aug. 9, 2023, and claims priority to German Application No. 10 2022 120 184.8, filed on Aug. 10, 2022. The contents of International Application No. PCT/EP2023/072089 and German Application No. 10 2022 120 184.8 are incorporated by reference herein in their entireties.

### FIELD

The present invention relates to computer-implemented methods, a server, a client, a network system and computer-readable storage media which enable printing on a medium, in particular a wallpaper, a placard or a banner, in a surface-filling manner.

### BACKGROUND

From JP 2002-132 330 A, a method is known for ordering wallpaper in which an image is printed several times side by side and one above the other on the wallpaper. A repetition and a shift of the image on the wallpaper can be adjusted by a user.

A similar method is also known from US 2001/0017089 A1.

JP 2004-086 746 A discloses a method for creating interior decorations, e.g. wallpapers, which have a wood or stone look. For this purpose, an original image is arranged one above the other and side by side several times, wherein vertical rows are shifted relative to each other.

WO 03/087977 A2 discloses a method for printing different substrates, e.g. wallpapers, posters, greeting cards, etc., in which a user selects an image via a website, for example, and adapts the image according to his/her wishes. The adjustments are then transferred to a server and the image is generated again according to the adjustments, transferred to the website again and displayed so that the user can check his/her adjustments. As a result, a new image is generated and transferred to the website each time the user makes an adjustment.

However, when printing a large-area or large-format medium in a surface-filling manner, such as wallpaper, a poster or a banner, it is necessary for the original image to have a sufficient size and resolution to ensure adequate print quality. As a result, the usability of the website may decrease if the adjusted image is transmitted repeatedly.

### SUMMARY

It is therefore the object of the present invention to provide a computer-implemented method, a server, a client, a network system and computer-readable storage media which enable printing on a medium in a surface-filling manner, while at the same time ensuring operability or user-friendliness when generating the medium. In addition, high print quality of the medium is to be ensured.

A computer-implemented method according to the invention, executable by a server, comprises the following steps.

First, an original image is loaded from the storage of the server. The original image comprises an image section that is to be printed in a surface-filling manner or over the entire surface of a medium, and is stored in advance in the storage of the server by an operator of the server.

Additionally or alternatively, the original image may also be transferred to the server via a client described later and may be stored in the storage of the server. Surface-filling means that images are not arranged next to or on top of each other on the medium and the medium is only printed with a single image.

The original image is then scaled down and/or compressed to a thumbnail image. The thumbnail image therefore requires less storage space than the original image. It should be noted, however, that the thumbnail image is still detailed enough that the image section of the original image that is to be printed on the medium remains identifiable.

The thumbnail image is then transmitted to the client, and a medium size of the medium to be printed on and features of a thumbnail image region, which corresponds to the medium size and a desired content of the medium to be printed on in the thumbnail image, are received by the client.

The thumbnail image therefore specifies the image section to be printed on the medium in the thumbnail image.

The thumbnail image region is then transformed to the original image in order to obtain an original image region that is to be printed on the medium in a surface-filling manner. Since the thumbnail image has a different size and/or resolution than the original image, the two images also have different coordinate systems. Transforming the thumbnail image region to the original image therefore corresponds to a coordinate transformation.

Finally, a printing command for printing the original image region in a surface-filling manner onto the medium is issued to a printer. The printer then prints the original image region in a surface-filling manner onto the medium. The printer may also print the original image region on medium material that is larger than the medium and then cut the medium material to the desired medium size.

The method according to the invention enables printing on the medium in a surface-filling manner. By downscaling and/or compressing the original image to a thumbnail image, the amount of data to be transmitted from the server to the client is reduced, so that the usability of the client is improved, in particular loading times at low transmission rates are shortened.

Preferably, before transmitting the thumbnail image to the client, a maximum medium size, in particular a maximum medium height and a maximum medium width, can be determined based on a size and a resolution of the original image. When transmitting the thumbnail image, the maximum medium size can then also be transmitted. Accordingly, the medium size that can be input into the client can be limited to the maximum medium size, so that a sufficient print quality, in particular a resolution, of the medium is ensured. In addition, a maximum medium size may also be defined by the specifications of the printer used.

Advantageously, the thumbnail image may be compressed by converting it to jpg or WebP format. The original image may be saved in png, jpg, svg or tiff format and a file size can be reduced by converting it to jpg or WebP format. Consequently, the amount of data can also be effectively reduced when transmitting the thumbnail image.

Another computer-implemented method according to the invention, which is executable by a client, in particular a web client or an application of a computer, of a smartphone, of a tablet or of another terminal device, comprises the following steps.

First, the thumbnail image is received by the server. Since the thumbnail image had previously been downscaled and/or compressed by the server, only a reduced amount of data needs to be transferred.

A medium size of a medium to be printed on, in particular by a user of the client, is then input into the client. The medium is preferably a placard, poster or banner with a rectangular shape. Accordingly, a length and a width of the rectangle has to be input. However, the medium may also have a different shape. Examples are a circle, an ellipse, a triangle, other polygons or a user-defined format that has cut-outs and protrusions, for example. The shapes may be input by inputting corner marks or a center point and associated radii. Alternatively, a spline or polynomial chain may be input.

When the medium size has been input, a thumbnail image region is defined that corresponds to the medium size, i.e. a format of the medium, and to a desired content of the medium to be printed on in the thumbnail image. It should be noted that the format of the medium and the format of the thumbnail image or of the original image may differ. The thumbnail image region is determined in particular using a graphical user interface that enables a real image display, such as a website. Preferably, regions of the thumbnail image that are contained in the thumbnail image region are highlighted. This can be achieved, for example, by displaying these regions normally, while regions outside the thumbnail image region are displayed with a lower contrast and/or a lower brightness and/or a lower saturation. Consequently, it is not necessary for a new image to be generated by the client each time it is adjusted, and the user of the client can reliably specify a content of the thumbnail image region.

Finally, the input medium size and the features of the thumbnail image region are transferred to the server. As a result, it is not necessary for an image edited or cropped by the client to be transferred back to the server, so that the amount of data to be transferred can be reduced.

The thumbnail image region may be defined in particular by rotating the thumbnail image. The thumbnail image may also be rotated in certain angular steps, e.g. in 45° or 90° steps. Additionally or alternatively, the thumbnail image region may be defined by mirroring the thumbnail image. Mirroring may be limited in particular to mirroring the thumbnail image on a central horizontal axis or a central vertical axis. Additionally or alternatively, if the input medium size is smaller than the maximum medium size, the setting of the thumbnail image region may include enlarging the thumbnail image. Consequently, the thumbnail image is displayed enlarged in the thumbnail image region. Through the above measures, the user can set the thumbnail image region in the thumbnail image according to his/her requirements. As a result, the content of the medium can also be easily defined.

The features of the thumbnail image region may include the shape and size of the thumbnail image region. As is known, a pixel image may be regarded as a coordinate system and the information about the shape and size of the thumbnail image region may be specified, for example, using a functional equation. If the medium in particular is a rectangle, it is already sufficient if the features of the thumbnail image region comprise X and Y coordinates of at least two diagonally opposite corner marks of the thumbnail image region. Alternatively, the X and Y coordinates of a corner mark together with a length and a width of the thumbnail image region may also be present in the features of the thumbnail image region so that the second corner mark of the rectangular thumbnail image region can be calculated. The length and the width of the thumbnail image region are specified as positive or negative values according to the propagation direction of the thumbnail image region from the corner mark. Particularly preferably, the corner mark is transmitted as an offset from an upper left corner of the thumbnail image, which is therefore used as the coordinate origin. Alternatively or additionally, the features of the thumbnail image region may include a size of the thumbnail image. However, the size of the previously transmitted thumbnail image region may also be saved by the server. Alternatively or additionally, the features of the thumbnail image region may include a rotation angle of the thumbnail image and/or mirroring of the thumbnail image and/or a magnification factor of the thumbnail image. Consequently, an exact determination of the defined thumbnail image region is possible by the server to which the features of the thumbnail image region are transmitted, and consequently also an exact transformation of the thumbnail image region to the original image for generating the original image region.

Preferably, a length of a longer side of the thumbnail image is 1920 pixels. Even more preferably, a length of a longer side of the thumbnail image is 1000 pixels. These lengths make it possible to effectively reduce the amount of data required for the transmission of the thumbnail image, while still ensuring a level of detail of the thumbnail image for selecting the thumbnail image region. Particularly preferably, a type of client is determined by the server and the length of the longer side of the thumbnail image is determined according to the type of client. If, for example, it is detected that the client is a PC or a laptop, the length of the longer side may be set to 1920 pixels. On the other hand, if, for example, the client is a smartphone or tablet, the length of the longer side may be set to 1000 pixels.

In addition, the resolution of the thumbnail image region may be 72 dpi. If the resolution of the original image is less than 72 dpi, the lower resolution (e.g. 70 dpi) may of course also be used. As a result, the thumbnail image is optimized for display on the client and the amount of data to be transferred from the server to the client can be efficiently reduced.

In particular, the medium may have a minimum medium size of 1 m by 1 m. A sufficiently large original image with a sufficient resolution is required for these media sizes. Consequently, an effective reduction in the amount of data required to transfer the thumbnail image is also achieved. As already mentioned, the medium in particular is a wallpaper, poster or banner that is applied in one piece, i.e. without joining strips together. An example of this is a removable wallpaper known from EP 3 721 007 A1. The content of EP 3 721 007 A1 is incorporated herein by reference.

The original image should have a minimum size of 2700 pixels by 2700 pixels and a minimum resolution of 70 dpi for the specified medium size. The use of an original image with these properties ensures a high print quality of the medium.

A server according to the invention comprises a storage in which an original image is stored, a network interface configured to communicate with a network, such as the Internet, and a processor. A computer program is stored in the storage of the server which, when executed by the processor, causes the processor to perform the steps of the computer-implemented method. The processor is therefore programmed to perform the following steps: loading an original image from the storage; downscaling and/or compressing the original image to a thumbnail image; transmitting the thumbnail image to a client via the network interface; receiving a medium size of a medium to be printed on and features of a thumbnail image region corresponding to the medium size and a desired content of the medium to be printed on in the thumbnail image from the client via the network interface; transforming the thumbnail image region to the original image to obtain an original image region to be printed on the medium in a surface-filling manner, and issuing a printing command to a printer for printing the original image region on the medium in a surface-filling manner. The server thus provides the beneficial effects of the computer-implemented method described above.

A client according to the invention comprises a storage, a network interface configured to communicate with a network, such as the Internet, and a processor. A computer program is stored in the storage of the client which, when executed by the processor, causes to perform the steps of the computer-implemented method. Accordingly, the processor is programmed to perform the following steps: receiving a thumbnail image from a server via the network interface and storing the thumbnail image in the storage; inputting a medium size of a medium to be printed on; setting a thumbnail image region corresponding to the medium size and a desired content of the medium to be printed on in the thumbnail image; and transmitting the medium size and features of the thumbnail image region to the server via the network interface. The client thus provides the beneficial effects of the computer-implemented method described above.

A network system according to the invention comprises the server and the client. It should be noted that a plurality of servers and clients may also be present in the network system. Furthermore, the network system comprises a printer configured to receive the printing command from the server and subsequently print the original image region onto the medium in a surface-filling manner. A network of the network system may be the Internet, so that the client can design a medium from anywhere in the world and order the print in a surface-filling manner.

Furthermore, the present invention comprises a computer-readable storage medium comprising commands which, when executed by a computer, in particular a server, cause the computer to execute the computer-implemented method first described.

The present invention further comprises a computer-readable storage medium comprising commands which, when executed by a computer, in particular a client, cause the computer to execute the other computer-implemented method.

The subject matters of the present invention enable printing on a medium in a surface-filling manner, in particular a wallpaper, a poster or a banner, while at the same time reducing the amount of data to be transmitted. Consequently, the usability of a client can be improved. In addition, the required print quality of the medium can be ensured.

### BRIEF DESCRIPTION OF THE DRAWINGS

Embodiments of the present invention are described below with reference to the accompanying Figures.

FIG. 1 shows a network system in which a server, a client and a printer can communicate with each other via a network, according to an embodiment of the present invention;

FIG. 2A and FIG. 2B show a flow diagram showing the steps of a method according to the embodiment of the present invention;

FIG. 3 shows processing for downscaling and/or compressing an original image to a thumbnail image; and

FIG. 4 shows the thumbnail image in which a thumbnail image region is defined, and processing for transforming the thumbnail image region to the original image to generate an original image region.

### DETAILED DESCRIPTION

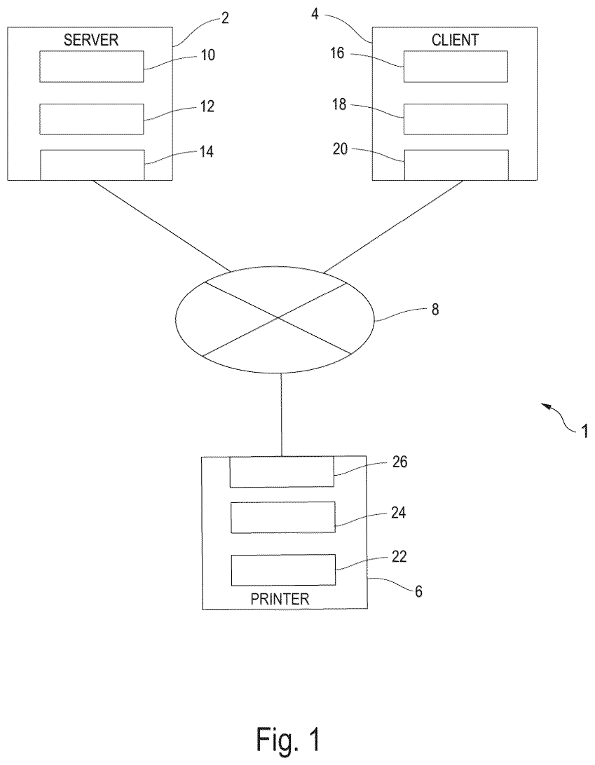

FIG. 1 shows a network system 1 according to an embodiment of the present invention, comprising a server 2, a client 4 and a printer 6, which can communicate with each other via a network 8, such as the Internet. It should be noted that a network system 1 is shown with only one server 2, one client 4 and one printer 6, but the network system 1 may well have a plurality of servers 2, clients 4 and printers 6 which are set up or present at different locations.

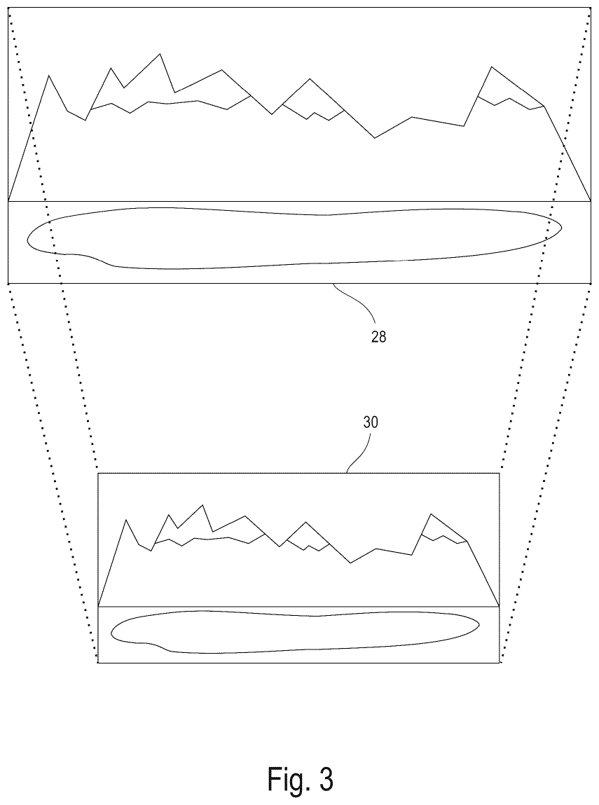

The server 2 has a storage 10, a processor 12 and a network interface 14. At least one original image 28 (see FIG. 3), which is described later, and a computer program are stored in the storage 10. The processor 12 is configured to read the computer program stored in the storage 10, and is thereby programmed to execute steps of a method according to the present embodiment. The processor 12 may also transmit data to or receive data from the network 8 via the network interface 14. The network interface 14 may be a wireless or a wired network interface. Data received via the network interface 14 may be stored in the storage 10 by the processor 12.

The client 4 has a storage 16, a processor 18 and a network interface 20. A computer program is stored in the storage 16. The processor 18 is configured to read the computer program stored in the storage 16, and is thereby programmed to execute steps of the method according to the present embodiment. The processor 18 may also transmit data to or receive data from the network 8 via the network interface 20. The network interface 20 may be a wireless or a wired network interface. Data received via the network interface 20 may be stored in the storage 16 by the processor 18.

The printer 6 also has a storage 22, a processor 24 and a network interface 26. A computer program is stored in the storage 22 and the processor 24 is configured by executing the computer program to receive a printing command via the network interface 26 and to print a medium described later. The network interface 26 can be configured as a wireless or wired network interface. Alternatively, the printer 6 can also be connected directly to the server 2.

As mentioned above, computer programs are stored in the storage 10 of the server 2 and in the storage 16 of the client 4, each of which can be read by the processors 12, 18 to configure them to cooperate to execute the method according to the present embodiment.

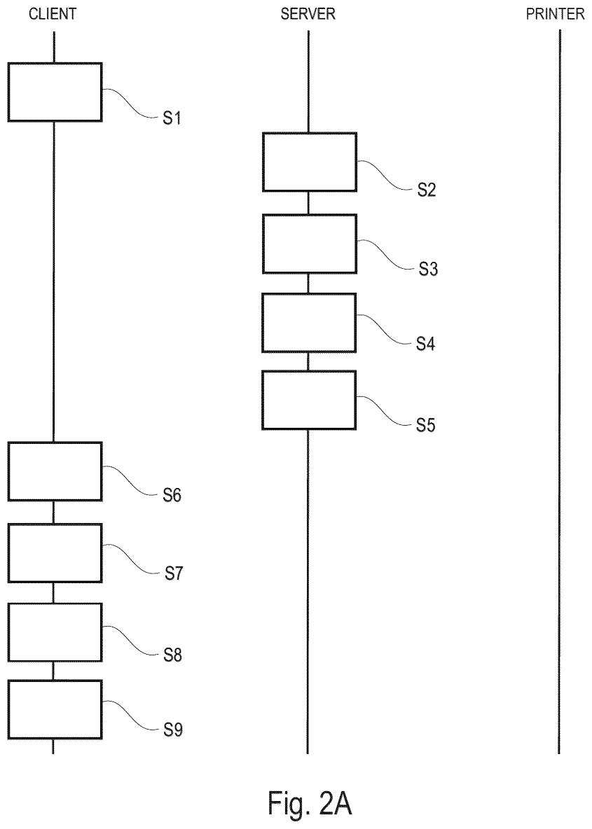

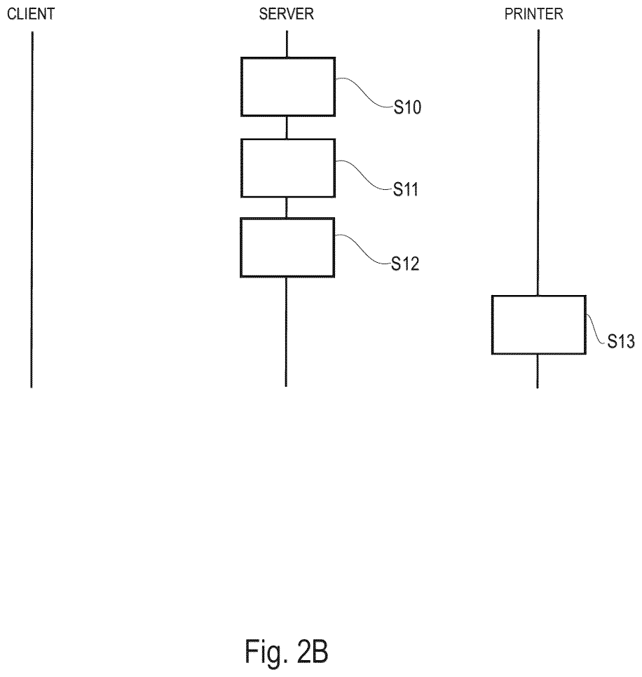

The individual steps of the method according to the present embodiment are described below with reference to the flow diagram in FIGS. 2A and 2B. It should be noted that the flow diagram in FIG. 2B is the continuation of the flow diagram in FIG. 2A.

In step S1, an image to be printed on the medium can be selected by the client 4, e.g. via a website provided by the server 2 and accessed by the client 4, and information allowing the server 2 to identify the image may be transmitted from the client 4 to the server 2 via the network 6. The image may also be selected via an application installed on the client 4. Alternatively, an image may also be uploaded from the client 4 to the server 2 via the network 6. The server 2 then saves the image as the original image 28 in the storage 10. The website or the application on the client 4 may again be used for this.

In the present embodiment, the medium is in particular a wallpaper, a poster or a banner which is to be applied in one piece, i.e. without joining sheets together, for example on a wall or a placard. An example of this is a removable wallpaper known from EP 3 721 007 A1. The content of EP 3 721 007 A1 is incorporated herein by reference. The medium in the present embodiment has a rectangular shape and the minimum medium size is 1 m by 1 m.

In step S2, the original image 28 (see FIG. 3), which corresponds to the image selected in step S1, is loaded from the storage 10 of the server 2. As already mentioned, the medium has a minimum size of 1 m by 1 m. For this medium size, a sufficiently large original image 28 with a sufficient resolution is required. The original image 28 should therefore have a minimum size of 2700 pixels by 2700 pixels and a minimum resolution of 70 dpi in order to ensure a sufficiently high print quality of the medium.

In step S3, the original image 28 is downscaled and/or compressed to a thumbnail image 30. The downscaling/compression of the original image 28 to the thumbnail image 30 is shown in FIG. 3. The original image 28 shows a mountain range and a lake in front of it. During downscaling/compression, the size of the thumbnail image 30 is reduced compared to the size of the original image 28. In the thumbnail image 30, the mountain range and the lake in front of it are still shown in sufficient detail so that the content of the original image 28 is still recognizable in the thumbnail image 30.

A length of a longer side of the thumbnail image 30 may preferably be set to 1920 pixels and even more preferably to 1000 pixels. Particularly preferably, the server 2 detects a type of client 4 and the length of the longer side of the thumbnail image 30 is determined depending on the type of client 4. If, for example, it is detected that the client 4 is a PC or laptop, the length of the longer side may be set to 1920 pixels. On the other hand, if, for example, the client 4 is a smartphone or tablet, the length of the longer side of the thumbnail image 30 may be set to 1000 pixels. Alternatively or additionally, the original image 28, which may initially be stored in a png, jpg, svg or tiff format, may be compressed into the thumbnail image 30 by converting it into the jpg or WebP format.

Furthermore, the resolution of the thumbnail image 30 may also be reduced compared to the resolution of the original image 28. The resolution of the thumbnail image 30 may be particularly preferably set to 72 dpi. If the resolution of the original image 28 is less than 72 dpi, in particular the minimum required resolution of 70 dpi, this lower resolution may of course also be used.

Back to FIG. 2A. In step S4, a maximum medium size may optionally be determined based on a size and a resolution of the original image 28. In the present embodiment, the original image 28 has a rectangular shape (see FIG. 3), so that the maximum medium size comprises a maximum medium height and a maximum medium width. If the medium should then not have a rectangular shape, it is necessary that the maximum medium size lies within the rectangle determined above.

In step S5, the thumbnail image 30 is transmitted from the server 2 to the client 4. In the event that the maximum medium size is determined in step S4, the maximum medium size is also transmitted from the server 2 to the client 4 in step S5. It should be noted that a maximum medium size may be specified not only by the size or resolution of the original image 28. A maximum edge length of the medium may also be specified by a maximum printable width by the printer 6.

In step S6, the thumbnail image 30 is received by client 4. If the maximum medium size is transmitted in step S5, this is also received by client 4.

In step S7, a medium size of the medium to be printed on is input into the client 4 by a user. If the maximum medium size was received in S6, the medium size to be input may be limited to the maximum medium size. Consequently, it is ensured that the medium is not made too large by the user of the client 4, so that a high print quality of the medium and use of the specified printer 6 are ensured.

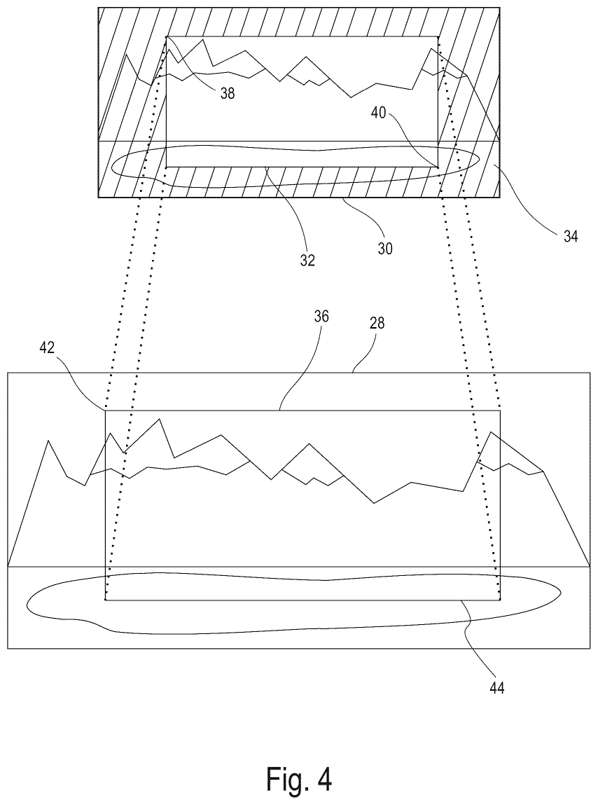

In step S8, a thumbnail image region 32 is set in the thumbnail image 30. The thumbnail image region 32 corresponds to the medium size, i.e. also to a format of the medium, and a desired content of the medium to be printed on in the thumbnail image 30. The setting of the thumbnail image region 32 in the thumbnail image 30 is shown in FIG. 4. The thumbnail image region 32 is set on the client 4 in particular via a graphical user interface that allows a real image display (also referred to as WYSIWYG (“What you see is what you get”)), such as the website or the application on the client 4. In particular, the thumbnail image region 32 is drawn in the thumbnail image 30 or displayed overlaid in the thumbnail image 30. It can be seen that the thumbnail image region 32 is set smaller than the thumbnail image 30 in the present embodiment. A region 34 outside the thumbnail image region 32 is shown hatched in FIG. 4. The region 34 may be displayed on the graphical user interface with a lower contrast and/or a lower brightness and/or a lower saturation. As a result, a user can reliably identify the content of the thumbnail image region 32.

In the present embodiment, the setting of the thumbnail image region 32 comprises in particular rotating the thumbnail image 30. Alternatively or additionally, the thumbnail image 30 may be mirrored. Moreover, if the maximum medium size was previously transmitted and the input medium size is smaller than the maximum medium size, the setting may alternatively or additionally comprise enlarging the thumbnail image 30. Consequently, the user of the client 4 can adapt the content of the thumbnail image region 32 and consequently also the content of the medium to be printed on according to his wishes. It should be noted that a maximum medium size may be reduced by setting the thumbnail image region 32, in particular by rotating the thumbnail image 28.

Back to FIG. 2A. In step S9, the input medium size and the features of the thumbnail image region 32 determined in step S8 are transmitted from the client 4 to the server 2. The features of the thumbnail image region 32 include a shape and a size of the thumbnail image region 32. This can be done, for example, by specifying coordinates of corner marks. Alternatively, the thumbnail image region 32 may be specified as a functional equation. In the present embodiment, the medium is rectangular and it is sufficient in particular to transmit X and Y coordinates of at least two diagonally opposite corner marks 38, 40 (see FIG. 4) of the thumbnail image region 32 to the server 2. Alternatively, only one corner mark, e.g. the X and Y coordinates of the corner mark 38, together with a length and a width may be present in the features of the thumbnail image region 32. The length and the width of the thumbnail image region 32 are present as positive or negative values according to the propagation direction of the corner mark 38. As a result, the second corner mark 40 may be calculated by the server 2. In particular, an upper left corner of the thumbnail image 30 may be used as the coordinate origin. Alternatively or additionally, a size of the thumbnail image 30 may be transmitted. If the thumbnail image 30 was rotated and/or mirrored and/or enlarged when setting the thumbnail image region 32, a rotation angle of the thumbnail image 30 and/or mirroring of the thumbnail image 30 and/or a magnification factor of the thumbnail image 30 may additionally be present in the features of the thumbnail image region 32. Consequently, a determination of the content of the medium to be printed on can be reliably and data efficiently transmitted from the client 4 to the server 2 by the thumbnail image region 32.

In step S10 (see FIG. 2B), the medium size of the medium to be printed on and the features of the thumbnail image region 32 are received by the server 2. As described above, the thumbnail image region 32 corresponds to the medium size and the desired content of the medium to be printed on in the thumbnail image 30.

In step S11, the thumbnail image region 32 is transformed to the original image 28 to obtain an original image region 36, which is to be printed on the medium in a surface-filling manner. A transformation of the thumbnail image region 32 onto the original image 28 is shown in FIG. 4. It can be seen that the content of the thumbnail image region 32 also corresponds to the content of the original image region 36. Since the original image 28 is larger than the thumbnail image 30 and/or has a higher resolution than the latter, a higher print quality is achieved during printing. Due to the higher number of pixels in the original image 28, the transformation of the thumbnail image region 32 to the original image 28 therefore corresponds to a coordinate transformation. In the present embodiment, in particular the corner mark 38 of the thumbnail image region 32 is transformed into the corner mark 42 of the original image region 36 and the corner mark 40 of the thumbnail image region 32 is transformed into the corner mark 44 of the original image region 36. Alternatively, for example, only the corner mark 38 of the thumbnail image region 32 may be transformed into the corner mark 42 of the original image region 36 and the length and width of the thumbnail image region 32, which may be present in the features of the thumbnail image region 32, may be transformed into a length and a width of the original image region 36 to calculate the corner mark 44 of the original image region 36.

In step $12, the server 2 generates a printing command for printing the original image region 36 onto the medium in a surface-filling manner and outputs it to the printer 6. In particular, the printing command may be output in pdf or eps format.

In step S13, the printer 6 receives the printing command from the server 2 and prints the medium having the original image region 36 as content. It should be noted that the medium may initially be printed on a larger medium material and the printing may also include cutting the medium material to the medium size.

In the present embodiment, it is therefore not necessary to transmit the original image 28 from the server 2 to the client 4. Furthermore, it is not necessary to transmit an image processed by the client 4 from the client 4 to the server 2. As a result, the amount of data to be transmitted is reduced and operability on the client 4 is improved. If the maximum medium size is also determined and transmitted, a high print quality of the medium can be ensured.

### LIST OF REFERENCE SIGNS

1 network system
2 server
4 client
6 printer
8 network
10 storage
12 processor
14 network interface
16 storage
18 processor
20 network interface
22 storage
24 processor
26 network interface
28 original image
30 thumbnail image
32 thumbnail image region
34 region outside the thumbnail image region
36 original image region
38 corner mark of the thumbnail image region
40 corner mark of the thumbnail image region
42 corner mark of the original image region
44 corner mark of the original image region

1-15. (canceled).

16. A computer-implemented method comprising the steps of:
loading an original image from a storage;
downscaling and/or compressing the original image to a thumbnail image;
transmitting the thumbnail image to a client;
receiving a medium size of a medium to be printed on and features of a thumbnail image region corresponding to the medium size and a desired content of the medium to be printed on in the thumbnail image from the client;
transforming the thumbnail image region to the original image to obtain an original image region to be printed on the medium in a surface-filling manner; and
issuing a printing command to a printer for printing the original image region on the medium in a surface-filling manner.

17. The computer-implemented method according to claim 16, further comprising the step of determining a maximum medium size based on a size and a resolution of the original image before transmitting the thumbnail image to the client, wherein the step of transmitting the thumbnail image comprises transmitting of the maximum medium size.

18. The computer-implemented method according to claim 16, wherein the thumbnail image is compressed by converting the thumbnail image to jpg format or WebP format.

19. The computer-implemented method according to claim 16, wherein the original image has a minimum size of 2700 pixels by 2700 pixels and a minimum resolution of 70 dpi.

20. The computer-implemented method according to claim 16, wherein the thumbnail image comprises a first side and a second side shorter than the first side, the first side having a length that is 1920 pixels.

21. The computer-implemented method according to claim 16, wherein the thumbnail image comprises a first side and a second side shorter than the first side, the first side having a length that is 1000 pixels.

22. The computer-implemented method according to claim 16, wherein the medium has a minimum medium size of 1 m by 1 m.

23. A server comprising:
a processor programmed to perform the computer-implemented method according to claim 16;
a storage in which an original image is stored; and
a network interface.

24. A network system comprising:
the server according to claim 23; and
a printer configured to receive the printing command from the server and to print the medium.

25. A computer-readable storage medium comprising commands which, when executed by a computer, cause the computer to execute the computer-implemented method according to claim 16.

26. A computer-implemented method comprising the steps of:
receiving a thumbnail image from a server;
inputting a medium size of a medium to be printed on;
setting a thumbnail image region corresponding to the medium size and a desired content of the medium to be printed on in the thumbnail image; and
transmitting the medium size and features of the thumbnail image region to the server.

27. The computer-implemented method according to claim 26, wherein:
the step of receiving the thumbnail image comprises receiving a maximum medium size, and
the medium size to be input is limited to the maximum medium size.

28. The computer-implemented method according to claim 27, wherein the step of setting the thumbnail image region comprises enlarging the thumbnail image when the medium size that is input is smaller than the maximum medium size.

29. The computer-implemented method according to claim 26, wherein the step of setting the thumbnail image region comprises rotating the thumbnail image and/or mirroring the thumbnail image.

30. The computer-implemented method according to claim 26, wherein the features of the thumbnail image region include at least one of:
a shape and a size of the thumbnail image region;
a size of the thumbnail image;
a rotation angle of the thumbnail image;
a mirroring of the thumbnail image; or
a magnification factor of the thumbnail image.

31. The computer-implemented method according to claim 26, wherein the thumbnail image comprises a first side and a second side shorter than the first side, the first side having a length that is 1920 pixels or 1000 pixels.

32. The computer-implemented method according to claim 26, wherein the medium has a minimum medium size of 1 m by 1 m.

33. A computer-readable storage medium comprising commands which, when executed by a computer, cause the computer to execute the computer-implemented method according to claim 26.

34. A client comprising:
a storage;
a network interface; and a processor,
the processor programmed to perform the following steps:
receiving a thumbnail image from a server via the network interface and storing the thumbnail image in the storage;
inputting a medium size of a medium to be printed on;
setting a thumbnail image region corresponding to the medium size and a desired content of the medium to be printed on in the thumbnail image; and
transmitting the medium size and features of the thumbnail image region to the server via the network interface.

35. A network system comprising:
the client according to claim 34;
a server; and
a printer configured to receive a printing command from the server and to print the medium.
